(19) United States
(12) Patent Application Publication
(10) Pub. No.: US 2016/0146709 A1
(43) Pub. Date: May 26, 2016

(54) SYSTEM FOR PREPARING TIME SERIES DATA FOR FAILURE PREDICTION

(71) Applicants: Satyadeep DEY, Bangalore (IN); Markus DOEHRING, Heidelberg (DE); Martin KATO, Karlsruhe (DE); Jaakob KIND, Heidelberg (DE); Gudrun KLOSE, Gruenwald (DE); Robert LANG, Wiesloch (DE); Uta Maria LOESCH, Ubstadt-Weiher (DE); Christine PREISACH, Waghaeusel (DE); Christian THEILEMANN, Heidelberg (DE)

(72) Inventors: Satyadeep DEY, Bangalore (IN); Markus DOEHRING, Heidelberg (DE); Martin KATO, Karlsruhe (DE); Jaakob KIND, Heidelberg (DE); Gudrun KLOSE, Gruenwald (DE); Robert LANG, Wiesloch (DE); Uta Maria LOESCH, Ubstadt-Weiher (DE); Christine PREISACH, Waghaeusel (DE); Christian THEILEMANN, Heidelberg (DE)

(21) Appl. No.: 14/550,275

(22) Filed: Nov. 21, 2014

(51) Int. Cl. G01M 99/00

(52) U.S. Cl. CPC G01M 99/008

(57) ABSTRACT

A method includes receiving, at computing system, sensor data from a machine, preparing the sensor data for use by data mining algorithms, generating an analysis table based on the prepared sensor data, the analysis table including information and data for a plurality of instances for the machine, and using the information and data included in the analysis table to predict a failure of the machine.

### TECHNICAL FIELD

This description relates to predictive maintenance of machinery.

### BACKGROUND

Machinery (equipment) can require periodic maintenance in order for it to remain functional and in order to prevent breakdowns. The periodic maintenance is performed in order to avoid unexpected failures that require the machinery not be used or shut down for an amount of time. Shutting down or removing a piece of machinery unexpectedly from use for a period of time for maintenance and repairs can adversely affect a system that may use the equipment. For example, if a piece of equipment needs unexpected repairs that require it to be removed from service, the project that is using the equipment may experience unexpected delays.

Preventative maintenance can be performed on the machinery in order to avoid unexpected delays. In some cases, a technician can perform periodic inspection of the machinery in order to determine when the preventative maintenance should be performed. The maintenance can be scheduled such that it is performed before the machinery or equipment breaks down and at a time when a delay in service can be accommodated. In some cases, sensors incorporated and built into the machinery can monitor a state of the machinery. The technician can use the data received from the sensors to predict some future problems that may occur with the machinery and to prevent the problems before they occur by performing preventative maintenance.

### SUMMARY

According to one general aspect, a method includes receiving, at computing system, sensor data from a machine, preparing the sensor data for use by data mining algorithms, generating an analysis table based on the prepared sensor data, the analysis table including information and data for a plurality of instances for the machine, and using the information and data included in the analysis table to predict a failure of the machine.

Implementations may include one or more of the following features. For example, the machine can be included in a set of machines. Receiving sensor data from a machine can include receiving sensor data from each machine included in the set of machines. The analysis table can further include information and data for a plurality of instances for each machine in the set of the machine. Each instance can include at least one input variable and at least one target variable. The at least one target variable cna be indicative of a machine failure. The at least one target variable can be indicative of one of a failure occurrence in a history window, a failure occurrence in a lead time window, and a failure occurrence in a prediction window. The at least one input variable can be indicative of a state of the machine at a given point in time. The at least one input variable can be indicative of an aggregate of the sensor data that was measured before a given point in time. Generating the analysis table can include using one of backward windowing or forward windowing. The method can further include receiving an alert from the machine, the alert indicative of a specific state of the machine at a particular point in time, the alert having an associated timestamp indicative of the particular point in time.

In yet another general aspect, a computer program product is tangibly embodied on a non-transitory computer-readable storage medium and includes instructions that, when executed by at least one computing device, are configured to cause the at least one computing device to receive, at computing system, sensor data from a machine, prepare the sensor data for use by data mining algorithms, generate an analysis table based on the prepared sensor data, the analysis table including information and data for a plurality of instances for the machine, and use the information and data included in the analysis table to predict a failure of the machine.

Implementations may include one or more of the following features. For example, the machine can be included in a set of machines. Receiving sensor data from a machine can include receiving sensor data from each machine included in the set of machines. The analysis table can further include information and data for a plurality of instances for each machine in the set of the machine. Each instance can include at least one input variable and at least one target variable. The at least one target variable can be indicative of a machine failure occurring in one or more of a history window, a lead time window, and a prediction window. The at least one input variable can be indicative of a state of the machine at a given point in time. The at least one input variable can be indicative of an aggregate of the sensor data that was measured before a given point in time. Generating the analysis table can include using one of backward windowing or forward windowing.

In another general aspect, a system includes a machine, and a computer system including a server and a database configured to store an analysis table. The machine includes a plurality of sensors. The plurality of sensors are configured to provide measurement data at an observation time. The measurement data is indicative of a state of the machine. The server is configured to receive the measurement data from the machine, to generate the analysis table that includes an instance for the machine, and to determine a failure of the machine based on the state of the machine. The instance is based on the observation time for the machine and includes the measurement data and the state of the machine.

Implementations may include one or more of the following features. For example, the observation time can be before a start of a lead time window and a start of a prediction window. The observation time can be during a history window, the state of the machine can be a failure state, and the analysis table may not include an instance for the machine based on the observation time for the machine.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system that includes an automated failure prediction system installed on a computer system for use with a set of machines.

FIG. 2 is an example timeline that shows example failure intervals for a machine.

FIG. 3 is an example timeline that shows indicators of measurements of sensor data along the timeline for a machine.

FIG. 4 is an example of an abstract representation (structure or template) of an analysis table prepared by and for use by an automated failure prediction system.

FIG. 5 is an example timeline showing the principle of backward windowing for use in failure prediction for a machine.

FIG. 6 shows an example timeline when a failure occurs during a lead time, before an observation time and during a data window, and outside of a prediction window, a lead time, and a data window.

FIG. 7 an example of a second analysis table prepared by and for use by an automated failure prediction system.

FIG. 8 an example of a third analysis table prepared by and for use by an automated failure prediction system.

FIG. 9 shows an example flowchart for generating and using an analysis table.

FIG. 10 is a flowchart that illustrates a method for predicting a machine failure.

The details of one or more implementations are set forth in the accompanying drawings and the description below. Other features will be apparent from the description and drawings, and from the claims.

### DETAILED DESCRIPTION

This document describes data mining systems and methods for preparing failure prediction models for machinery and equipment. The data mining system and methods use information and data received from input sensors included in the machinery. Failure prediction is concerned with predicting imminent failures of machinery based on available sensor data. If a failure can be predicted, the machinery can be removed from service before it breaks down and at a time when its removal has minimal impact on the process or service being performed by the machinery.

A failure prediction model for a machine can be learned from historical information and data associated with the machine. The historical information and data can include a large amount of time-series data that includes measured sensor values for sensors included on the machine at certain intervals of time. The data can be fine-grained being received continuously over the time that the machine is in operation. For example, data can be continuously obtained/received every few seconds 24 hours per day, seven days per week. This can result in a very large amount of raw data that is not in a format suitable for input to and analysis by a failure prediction model.

In some cases, this vast amount of data can be sorted and scaled back to use only a subset of the data for use by the failure prediction model. In this case, a user would need to determine which parameters included in the data are relevant for failure prediction and how often information about these parameters is needed. In addition or in the alternative, a determination would need to be made regarding the impact of the parameters on the preparation of the machine learning input data. The data can be represented in a tabular form for use by data mining algorithms. The data mining algorithms can further prepare the data for model learning. An analysis table can be used as input for machine learning algorithms and for the training of a failure prediction model.

A failure prediction model can use a specific type of input data that can be represented in the form of an analysis table that defines a data set for one or more machines (a set of machines) and sensor data for each of the machines included in the set. A row in the analysis table represents an instance in time of a measurement for a machine and the values in the columns represent the data obtained from sensors included in the machine at the instance in time. The analysis table can be used as input for machine learning algorithms and for the training of a failure prediction model.

Preparing the analysis table includes taking time-series raw sensor data for a machine and determining a set of domain-specific parameters that are relevant for failure prediction for the machine. For example, domain-specific parameters for failure prediction can include, but are not limited to, determining a time-series sampling step size (e.g., how often do we need to look at the returned sensor data from the machine) and a minimum recovery time of the machine after a failure does occur.

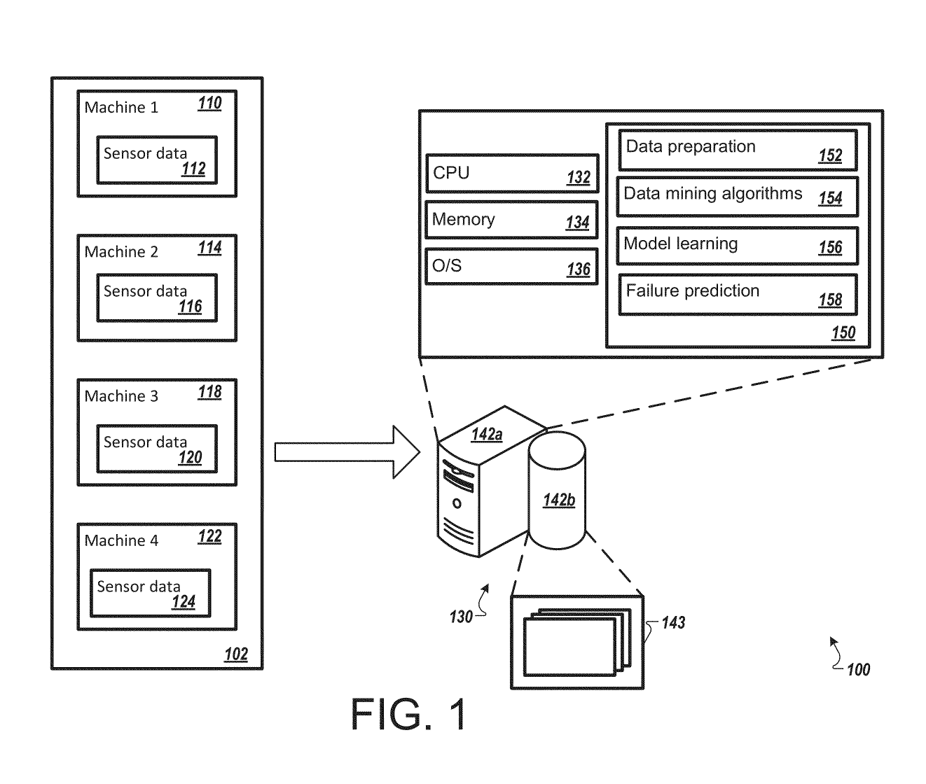

FIG. 1 is a diagram of an example system 100 that includes an automated failure prediction system 150 installed on a computer system 130 for use with a set of machines 102. Sensor data 112, 116, 120, 124 is recorded/stored by respective machines 110, 114, 118, and 122. The sensor data 112, 116, 120, 124 can be used to describe a state of a machine at a point in time when the sensor data was obtained/gathered by the respective machine 110, 114, 118, and 122.

The computer system 130 receives the sensor data 112, 116, 120, 124 from the respective machines 110, 114, 118, and 122. In some implementations, the machines 110, 114, 118, and 122 can be directly interfaced with/connected to the computer system 130. In some implementations, the machines 110, 114, 118, and 122 can be interfaced with/connected to the computer system 130 by way of a network. In some implementations, the network can be a public communications network (e.g., the Internet, cellular data network, dialup modems over a telephone network) or a private communications network (e.g., private LAN, leased lines). In some implementations, the machines 110, 114, 118, and 122 can communicate with the network using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

The centralized computer system 130 can include one or more computing devices (e.g., a server 142a) and one or more computer-readable storage devices (e.g., a database 142b). The database 142b can include records 143. For example, the records 143 can include one or more analysis tables, and raw sensor data received from the set of machines 102. The server 142a can include one or more processors (e.g., server CPU 132), and one or more memory devices (e.g., server memory 134). The server 142a can execute a server O/S 136. In some implementations, the computer system 130 can represent multiple computing devices (e.g., servers) and multiple computer-readable storage devices (e.g., databases) working together to perform server-side operations.

In some implementations, the sensor data 112, 116, 120, 124 may be stored locally on the respective machines 110, 114, 118, and 122 and provided to/sent to the computer system 130 on a periodic basis (e.g., once per minute, once per minute, once per hour, once per day) for subsequent storage as raw data in the database 142b. In some implementations, the sensor data 112, 116, 120, 124 may be stored locally on the respective machines 110, 114, 118, and 122 and provided to/sent to the computer system 130 when requested by the computer system 130.

The automated failure prediction system 150 includes a data preparation module 152, data mining algorithms 154, a model learning module 156, and a failure prediction module 158. The automated failure prediction system 150 will be described with reference to the figures described herein.

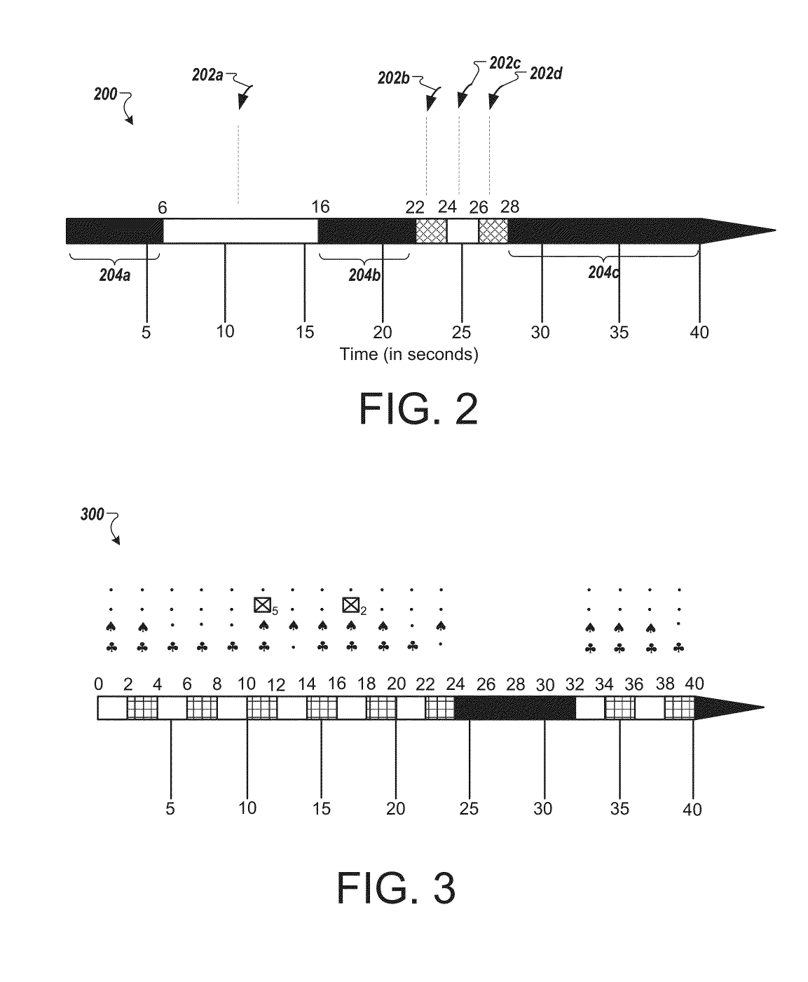

FIG. 2 is an example timeline 200 that shows example failure intervals 202a-d for a machine. For example, referring to FIG. 1, the timeline could be for any of the machines 110, 114, 118, and 122 in the set of machines 102. During the time intervals 204a-c the machine is in an off-state (the machine is turned off) and no sensor data is gathered.

A failure time t_{ƒ} can be a point in time (e.g., failure intervals 202a-d) when a machine fails. After a failure occurs, the machine will not be working (will be offline) for a time interval Δ_{ƒ}, where the length of the time interval Δ_{ƒ} depends on the failure (as shown in FIG. 2). A failure occurrence indicator ƒ₀(m, t) is defined by Equation 1 and indicates that a failure ƒ₀ of a machine m at a point in time t has occurred. Equation 1 returns a value equal to one if a failure occurs at a specific point in time (at a specific chronon).

$${f}_{0} ( m , t ) = \{ \begin{matrix}1 & ∃ f ∈ ℱ , {t}_{f} ⋀ {f}_{m} ( t ) = m \\ 0 & otherwise\end{matrix} \qquad Equation 1$$

A failure state indicator ƒₛ(m, t) is defined by Equation 2 and indicates that a failure state ƒₛ of a machine m existed at a point in time t during a chronon. Equation 2 returns a value equal to one if a failure occurs for a particular interval t_{ƒ} to t_{ƒ}+Δ_{ƒ}.

$${f}_{s} ( m , t ) = \{ \begin{matrix}1 & ∃ f ∈ ℱ , {f}_{m} ( f ) = m ⋀ t ∈ [ {t}_{f} , {t}_{f} + {Δ}_{f} ] \\ 0 & otherwise\end{matrix} \qquad Equation 2$$

Referring to Equation 1 and Equation 2 above, m is the machine or entity under observation (e.g., machine 110), t_{ƒ} is a point in time when the failure occurs, and F defines a set of all failures of which failure ƒ is a member. Each failure ƒ is associated with a machine as defined by a function ƒₘ where ƒₘ(ƒ)=m.

FIG. 3 is an example timeline 300 that shows indicators of measurements of sensor data along the timeline 300 for a machine. For example, referring to FIG. 1, the timeline could be for any of the machines 110, 114, 118, and 122 in the set of machines 102.

As shown in FIG. 3, sensor data can be received every two time units or chronon (e.g., every two seconds, every two minutes, every two hours). As shown in the example timeline 300, each sensor included in a machine may not provide sensor data for each chronon.

A chronon c can be a minimum granularity that can be resolved on a time scale. A chronon can define a time interval of the form cᵢ=(t−1, t).

Given a set of machines (e.g., the set of machines 102 in FIG. 1) and sensor data 112, 116, 120, 124 for each of the respective machines 110, 114, 118, and 122 included in the set of machines 102, a failure prediction problem can be defined by Equation 3.

ƒ(t₀,m,Δₗ,Δₚ,Δₕ)=P(∃tε[t₀+Δₗ,t₀+ΔₗΔₚ]:ƒ₀(m,t)=1|{p(m,t₁),t₁ε[t−Δₕ,t₀]}∪{a|tₐε[t₀−Δₕ,t₀]}) Equation 3

Referring to Equation 3 above, m is the machine or entity under observation (e.g., machine 110). For example, the set of machines 102 can be represented as M where mεM. A failure, ƒ, is an event that occurs when the delivered service by the machine deviates from the expected service provided by the machine. Each failure can be associated with a machine and defined by a function ƒₘ(ƒ)=m.

An alert a is a value which is provided by a machine when the machine is in a specific state. The value may be sent between sensor data intervals. The alert can include a time stamp defined by tₐε [symbol] , where the alert time stamp tₐ indicates that the alert occurred in the chronon cₜ=(tₐ−1, tₐ). The time [symbol] is indicative of an age [symbol] associated with a machine. The time [symbol] can be a measurement at a point in time t where the state of the machine is assessed, and where (tε [symbol] )

An observation time t₀ can be a point in time where a state of a machine is assessed. An observation time can define a row in the analysis table. A distance between two sensor data measurements can be defined by a data window size Δ_{d}. For example, referring to the timeline 200 in FIG. 2, the data window size Δ_{d}=2 (two time units). If a measurement is recorded at time t then the next measurement is recorded at a time t+Δ_{d}. The data window size Δ_{d} is a multiple k of the chronon size c, where Δ_{d}=kc, and kε [symbol] . In some cases, sensor data measurements can occur regularly according to the data window size Δ_{d} though they may not be captured. For example, this can occur when the machine is in an off state.

A data package p(m,t) can be a set of measurements of sensor data for a machine m that is taken at the same point in time, t, at a chronon level. For example, a chronon can be an interval of time that can be considered a granularity of time. A lead time Δₗ is a time period needed to react to an imminent failure of a machine. The lead time Δₗ can be considered an early warning time. A time interval defining the lead time Δₗ is (t₀, t₀+Δₗ). A prediction window size Δₚ is a time period in which a prediction can be considered valid. The prediction window size Δₚ is a multiple k of the chronon c where Δₚ=kc and kε [symbol] . The prediction window Δₚ can be defined by the time interval (t₀+Δₗ,t₀+Δₗ+Δₚ). In order to ensure that a machine failure is included in and covered by the analysis table, the prediction window Δₚ is greater than or equal to a step size Δ₀. The step size Δ₀ is the time between assessments of a state of a machine. The step size Δ₀ is a multiple k of the chronon c where Δ₀=kc, kε [symbol] , and the step size Δ₀ is equal to or greater than the data window size Δ_{d}. The step size Δ₀ being equal to or greater than the data window size Δ_{d} is needed to ensure that new measurement data is available between state assessments of the machine. In addition or in the alternative, the step size Δ₀ can be aligned with a scoring scenario (e.g., score the assessment of the machine every hour). In addition or in the alternative, the step size Δ₀ can be used to determine a distance (based on chronons) between row entries for the same machine in the analysis table.

A history window size Δₕ can be a time period which is taken into account when describing a state of a machine. The history window can be defined as (t₀−Δₕ,t₀) (a time period represented by the history window size Δₕ that occurred before a particular observation time t₀). In the case where the history window size Δₕ is less than the data window size Δ_{d}, the most recent measurement of the sensors in the machine can be used for describing the state of the machine. In the case where the history window size Δₕ is greater than or equal to the data window size Δ_{d}, historical measurement data (measurement data for the sensors in the machine that was taken before the observation time t₀) can be used.

The prediction problem defined by Equation 4 can estimate the probability of the occurrence in the future of a failure, ƒ, in a time window starting at a lead time Δₗ for a machine. The probability can be calculated based on sensor measurements and alerts provided by the machine in a history window size Δₕ number of units before the predicted occurrence of the failure.

A data package p(m,t) can be a set of measurements of sensor data for a machine m that is taken at the same point in time, t, at a chronon level. For example, in some cases a chronon can be an interval of time that can be considered a granularity of time. It can be assumed that at the point in time, t, that each element in the data package will have either a set of measurements or no measurements at all.

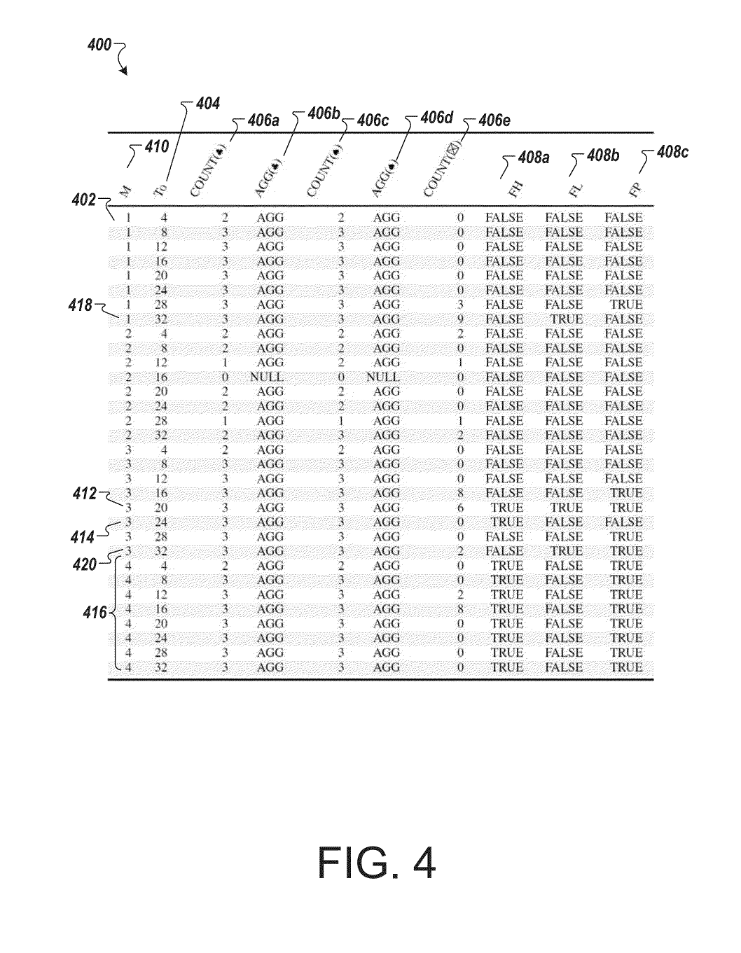

Referring to FIG. 1, an analysis table, examples of which are shown with reference to FIGS. 4, 8, and 9, can define a data set for use as training data and as input to a machine learning model (e.g., the model learning model 156). In addition, or in the alternative, an analysis table can define a data structure based on historical data that describes the state of one or more machines included in a set of machines (e.g., the set of machines 102).

FIG. 4 is an example of an abstract representation (structure or template) of an analysis table 400 prepared by and for use by an automated failure prediction system (e.g., the automated failure prediction system 150 shown in FIG. 1). Referring also to FIG. 1, an analysis table can define a data set for use as training data and as input to a machine learning model (e.g., the model learning model 156). In addition, or in the alternative, an analysis table can define a data structure based on historical data that describes the state of one or more machines included in a set of machines (e.g., the set of machines 102). The sensor data 112, 116, 120, 124 provided by the respective machines 110, 114, 118, and 122 and received by the server 142a can be raw data in a form that may not be suitable as input data for the data mining algorithms 154. The data preparation module 152 can take the raw sensor data 112, 116, 120, 124 and place it into a tabular form or structure for use by the data mining algorithms 154. The tabular structure of the analysis table can include rows and columns.

A row (e.g., row 402) in the analysis table 400 includes all of the information (data) describing an instance (a measurement at a point in time) for a machine (e.g., machine 1). The information and data includes input variables 406a-e, which can be used in a data model, and target variables 408a-c indicating whether or not the instance describes a machine failure. The information describing the instance can be considered a key. Each row entry in the analysis table 400 includes a machine ID 410 and a respective observation time 404 (a reference point in time) that can be considered the key. In the example analysis table 400, a forward windowing time stamp is presented.

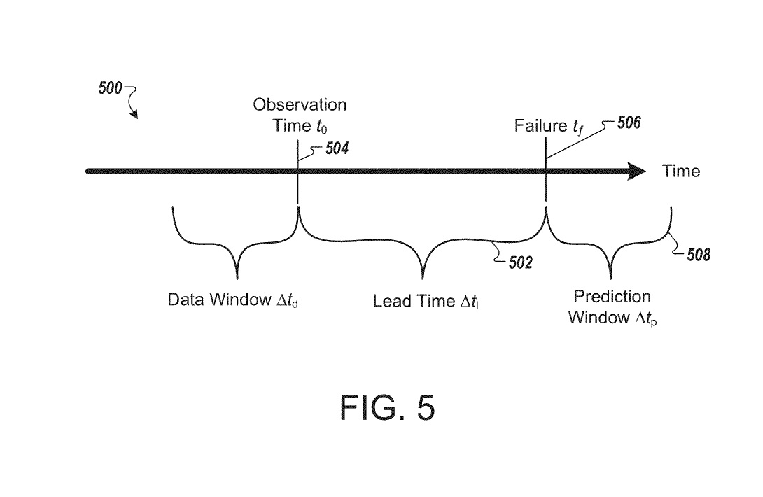

FIG. 5 is an example timeline 500 showing the principle of backward windowing for use in failure prediction for a machine. Referring to FIG. 1, the principle of backward windowing is to model machine failures so that sensor data measured before a lead time Δₗ 502 for a machine is used by the model learning module 156 but sensor data measured during the lead time Δₗ 502 is not used by the model learning module 156. As such, a machine failure is modeled by the model learning module 156 so that an observation time t₀ 504 corresponds with the start of the lead time Δₗ 502. The lead time Δₗ 502 then becomes the time interval before the occurrence of the machine failure at time t_{ƒ} 506 (t₀=t_{ƒ}−Δₗ).

When using backwards windowing, the data mining algorithms 154 generate negative instances for use by the model learning module 156 and for inclusion in an analysis table. The data mining algorithms 154 generate the negative instances by taking into account each observation time t₀ that is a multiple of the step size Δ₀ subtracted from the failure time t_{ƒ} for each failure of a machine. A machine learning algorithm used by the model learning module 156 can predict a point in time for the failure (e.g., the failure time t_{ƒ} 506) which occurs at the beginning of a prediction interval or prediction window of a prediction window size Δₚ 508.

Forward windowing differs from backward windowing in that forward windowing does not use information and data about failures when defining observation times. Forward windowing can define a time grid that is independent of machine failure timestamps. Forward windowing can be based on point in time when a machine state is assessed and is the start of a machine providing data. When using forward windowing for multiple machines, all of the multiple machines provide data on the same time grid.

Referring to FIG. 1, when using forward windowing, an observation timestamp (a point in time when a machine state is assessed (sensor data is read by the machine)) can be defined as t₀=t₀+kΔ₀ where t₀ is a point in time when a machine (e.g., the machine 110) first starts obtaining and providing sensor data (e.g., sensor data 112) to the computer system 130 and Δ₀ is the step size.

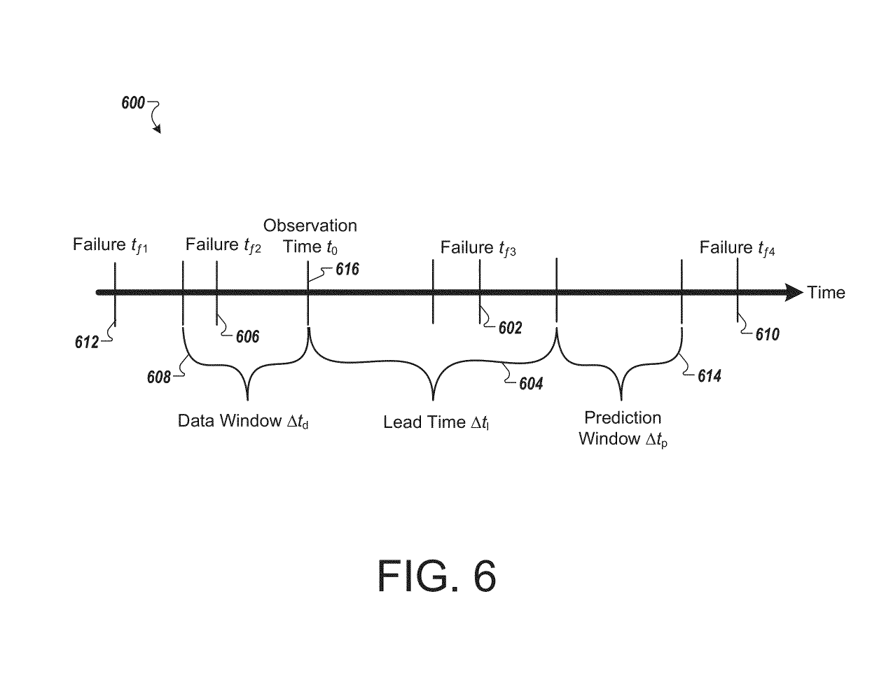

FIG. 6 shows an example timeline 600, based on forward windowing, when a failure 602 occurs during a lead time Δₗ 604, a failure 606 occurs before an observation time t₀ and during a data window of data window size Δ_{d} 608, and a failure 610 and a failure 612 that occur outside of a prediction window of prediction window size Δₚ 614, a lead time L 604, and the data window of data window size Δ_{d} 608.

When using forward windowing, one or more instances may be excluded from being used by the model training module 156 as the one or more instances may not be suitable for model learning for use in predicting a machine failure as they occur too close to a machine failure. The one or more instances may be considered unreliable (noisy) data. For example, instances that include a failure during a lead time (the failure 602 during lead time Δₗ 604) may be filtered out/excluded from use by the model learning module 156. The failure 602 occurs at a time t_{f3} where t₀<t_{f3}≦t₀+Δₗ. The occurrence of the failure 602 during the lead time Δₗ 604 raises the issue of what to do after a failure has already been predicted.

In another example, instances that include a failure that occurs close in time to an observation time t₀ (e.g., the failure 606 and an observation time t₀ 616) may be excluded from being used by the model training module 156 as the one or more instances may not accurately represent a machine failure. For example, the failure 606 can occur at a time t_{f2} where t₀−Δₕ<t_{f2}≦t₀, using a history window of history window size Δₕ. In these instances, it may be determined that the observation time t₀ 616 is too close to the occurrence of the failure 606.

The failure 610 and the failure 612 occur outside of the prediction window of prediction window size Δₚ 614, the lead time Δₗ 604, and the data window of data window size Δ_{d} 608. In some situations, data sampling close to the failure 610 and the failure 612 may be prevented or data sampled close to the failure 610 and the failure 612 may be ignored. If it is determined, however, that a machine performs normally even if a failure occurs, data sampling close to the failure 610 and the failure 612 may still occur. In some implementations, an incubation time window Δᵢ can be defined where data is sampled Δᵢ time units before a failure may be ignored.

In some implementations, a machine may need a recovery period of at least Δᵣ time units after resolution of a failure before it may be assumed that the machine is working/behaving properly. Data sampling can be prevented during the recovery time window Δᵣ and/or data sampled during the recovery time window Δᵣ can be ignored.

Referring back to FIG. 4, each instance (row) in the analysis table 400 is associated with target variables 408a-c that provide indications of failures or non-failures. Target variable 408a indicates whether a failure occurred during a history window. Target variable 408b indicates whether a failure occurred during a lead time window. Target variable 408c indicates whether a failure occurred during a prediction window. The model learning module 156 use the indications for the target variables 408a-c to learn machine state patterns based on the values for the input variables 406a-e. The data mining algorithms 154 can gather and provide the training data to the model learning module 156 for use in creating data models.

A target variable 408a-c can be associated with a value equal to “1” (TRUE) (indicative of a failure) or “0” (FALSE) (indicative of no failure) when used to model the sensor data and predict machine failures. The value of the target variable 408a-c provides an expected value for ƒ (t, m, Δₗ, Δₚ, Δₕ) where ƒ is a failure, m is a machine, t is a point in time, Δₚ is a prediction window size, Δₗ is a lead time, and Δₕ is a history window size. Predefined values for ƒ (t, m, Δₗ, Δₚ, Δₕ) are given by Equation 4.

$${f}_{0} ( m , ( {t}_{0} + {Δ}_{l} , {t}_{0} + {Δ}_{l} + {Δ}_{p} ) ) = \{ \begin{matrix}1 & ∃ t ∈ ( {t}_{0} + {Δ}_{l} , {t}_{0} + {Δ}_{l} + {Δ}_{p} ) \text{:} {f}_{0} ( m , t ) = 1 \\ 0 & otherwise\end{matrix} \qquad Equation 4$$

where ƒ₀(m,t) is a failure ƒ₀ of a machine m at a point in time t, and t₀ is an observation time. Instances associated with the beginning or start of a failure can be classified and considered as failures because a duration of a failure may be dependent on actions taken to resolve or correct the failure. When using Equation 5 in defining a failure ƒ, instances where a machine has a failure that occur during a time window defined as (t₀, t₀+Δₗ) but has no failure that occurs during a time window defined as (t₀+Δₗ, t₀+Δₗ+Δₗ) are classified as negative instances.

The input variables 406a-e can be used to describe a state of a respective machine at a given point in time. For example, the values for the input variables 406a-e included in the row 402 describe a state of a machine whose machine ID is included as the value for the machine ID 410 in the row 402 and at a point in time as indicated in the entry in the row 402 for the observation time 404. The input variables 406a-e provide values for and indications of received sensor data for the respective machine at the indicated observation time observation time for the instance represented by the row entry in the analysis table.

For example, attributes that can describe a machine state at an observation time t₀ can be functions as described in Equation 5.

ƒ: [symbol] ×( [symbol] ∩[1,Δₕ])×( [symbol] ∩[1,Δₕ])× [symbol] → [symbol] Equation 5

In Equation 5, for an attribute, the time [symbol] is indicative of an age [symbol] associated with a machine. As shown in Equation 5, an attribute is a function of (a part of) sensors measurements taken during a history window (t₀−Δₕ,t₀) (a sub-window) prior to the observation time t₀. The second parameter and the third parameter describe the sub-window considered in the function.

Equation 5 can be considered an abstract template for what is shown in Equation 6 and Equation 7 below.

For example, some attributes can be based on an aggregation of sensor measurements taken on a machine prior to an observation time t₀ for a state of a machine. The time indices used for the aggregation are relative to the observation time t₀, which is part of the keying of the entries in the analysis table. In some implementations, the aggregation of sensor measurements can be the sum of the occurrences of the sensor measurements,

For example, referring to FIG. 1, the machine 110 sends sensor data 112 every 30 minutes to the computer system 130. In this example, if the chronon is defined as a 30 minute interval, Equation 6 and Equation 7 can define function ƒ₁ and function ƒ₂, respectively, for the measurements.

ƒ₁(t₀,2,0,x)=max(x[t₀−2,t₀]) Equation 6:

where the function ƒ₁ is for a maximum value of a sensor measurement x taken at the chronon interval and within a 2 hour time span before the observation time.

ƒ₂(t₀,48,24,x)=stddev(x[t₀−48,t₀−24]) Equation 7:

where the function ƒ₂ is for a standard deviation of a sensor measurement x taken at the chronon interval and within a 12 hour time span that occurs 24 to 12 hours before the observation time.

The measurements (the measured sensor data) can be sent from the set of machines 102 to the computer system 130 at fixed points in time defined by the data window size Δ_{d}. In some implementations, an alert can occur at any point in time. The alert can then be mapped at a timestamp associated with the alert. For example, an alert can be counted in a data window where the timestamp associated with the timestamp falls. Attributes can be defined for a data window (t₀−Δ_{d},t₀) and an alert αᵢ as shown in Equation 8.

alertcount(aᵢ,t₀)=|alert_{type=a}_{ᵢ}_{,t}_{₀}_{-Δ}_{_{d}}_{<t}_{ₐ}_{≦t}_{₀}| Equation 8:

For example, referring to FIG. 1, the machine 110 sends sensor data 112 every 30 minutes to the computer system 130. In this example, if the chronon is defined as a 30 minute interval, Equation 9 and Equation 10 define function ƒ₃ and function ƒ₄, respectively, for the measurements.

ƒ₃(t₀,2,0,a)=Σᵢ₌₀²alertcount(a,t₀−i) Equation 9:

where the function ƒ₃ is the sum of alerts of type a that have occurred within the last hour (with two 30 minute consecutive intervals (chronons)) before the observation time.

ƒ₄(t₀,48,0,a)=Σᵢ₌₀⁴⁸alertcount(a,t₀−i) Equation 10:

where the function ƒ₄ is the sum of alerts of type a that have occurred within the last day (within the last 24 hours (within forty-eight 30 minute consecutive intervals (chronons))) before the observation time.

Referring again to FIG. 4, the analysis table 400 provides an example of forward windowing applied to example data (e.g., measurements and data for the set of machines 102 as shown in FIG. 1). The example data includes the parameters Δₚ=2, Δₕ=6, Δₗ=2, Δ₀=4, and AGGREGATES=ALL (i.e., no filtering is applied if windows are only sparsely filled; indicates if aggregations on sparsely filled intervals should be considered), NEG_FROM_POS=TRUE (i.e., negative examples are also generated from failing machines), and Δᵢ=0, Δᵣ=0.

For the parameters, Δₚ is a prediction window size, Δₗ is a lead time, Δₕ is a history window size, Δ₀ is a step size, Δᵢ is an incubation time window, and Δᵣ is a recovery time window.

The input variable 406a, COUNT( [symbol] ), is indicative of a number of values of the measure type ( [symbol] ) included in the history windows. The input variable 406b, AGG( [symbol] ) is indicative of an aggregation of the measure type ( [symbol] ) included in the history windows. The input variable 406c, COUNT( [symbol] ), is indicative of a number of values of the measure type ( [symbol] ) included in the history windows. The input variable 406d, AGG( [symbol] ), is indicative of an aggregation of the measure type ( [symbol] ) included in the history windows. The input variable 406e, COUNT( [symbol] ), is indicative of a number of event occurrences in the history windows. The target variable 408a, FH, is indicative of a failure occurrence in the history window. The target variable 408b, FL, is indicative of a failure occurrence in the lead time window. The target variable 408c, FP, is indicative of a failure occurrence in the prediction window.

The analysis table 400 includes failures that are in the history window (e.g., row 412, row 414 and rows 416) or the lead time window (e.g., row 418, row 412, row 420). In some implementations, these instances (rows) can be removed/eliminated from (filtered out of) the analysis table 400. For example, as described above, failures that occur during a lead time may be eliminated from the analysis table. In cases where a stop at predicted failure can occur, failures that occur during the history window may be eliminated from the analysis table.

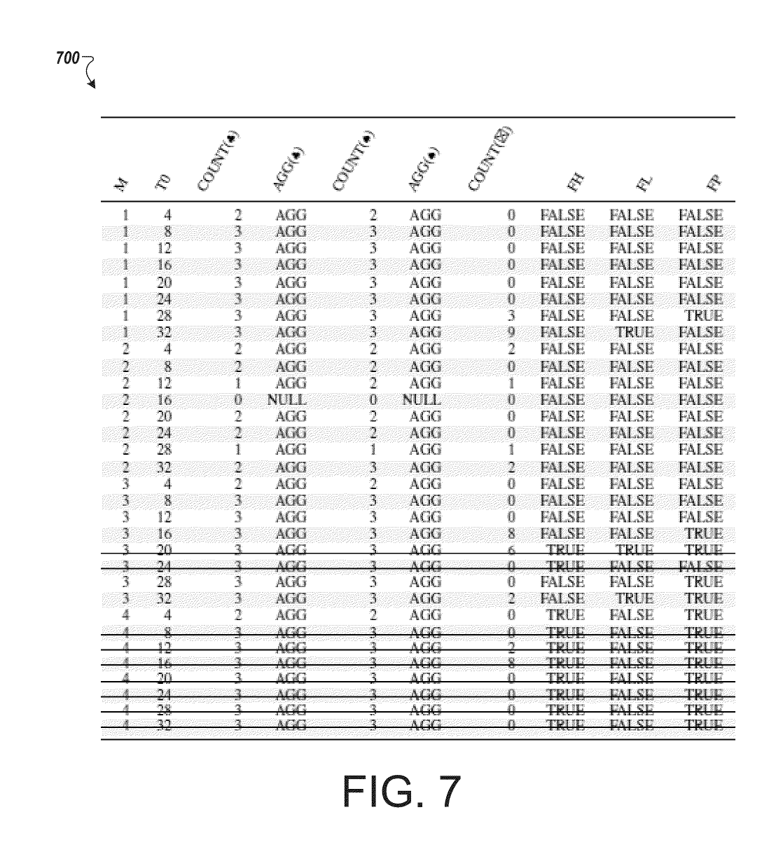

FIG. 7 an example of a second analysis table 700 prepared by and for use by an automated failure prediction system (e.g., the automated failure prediction system 150 shown in FIG. 1). The analysis table 700 uses the example data including the point parameters Δₚ=2, Δₕ=6, Δₗ=2, Δ₀=4, and AGGREGATES=ALL (i.e., no filtering is applied if windows are only sparsely filled; indicates if aggregations on sparsely filled intervals should be considered), NEG_FROM_POS=TRUE (i.e., negative examples are also generated from failing machines), and Δᵢ=0.

These parameters are the same as the parameters used in the example of the first analysis table 400 in FIG. 4. However, in the second analysis table 700, Δᵣ=4 (i.e., a minimum time before new instances can be generated after a detected failure is four chronons; a recovery time window is four chronons). Based on this new criteria, as shown in FIG. 7, some instances can be omitted/removed/filtered out of the second analysis table 700 (as indicted by the rows that are crossed out).

For the parameters, Δₚ is a prediction window size, Δₗ is a lead time, Δₕ is a history window size, Δ₀ is a step size, Δᵢ is an incubation time window, and Δᵣ is a recovery time window.

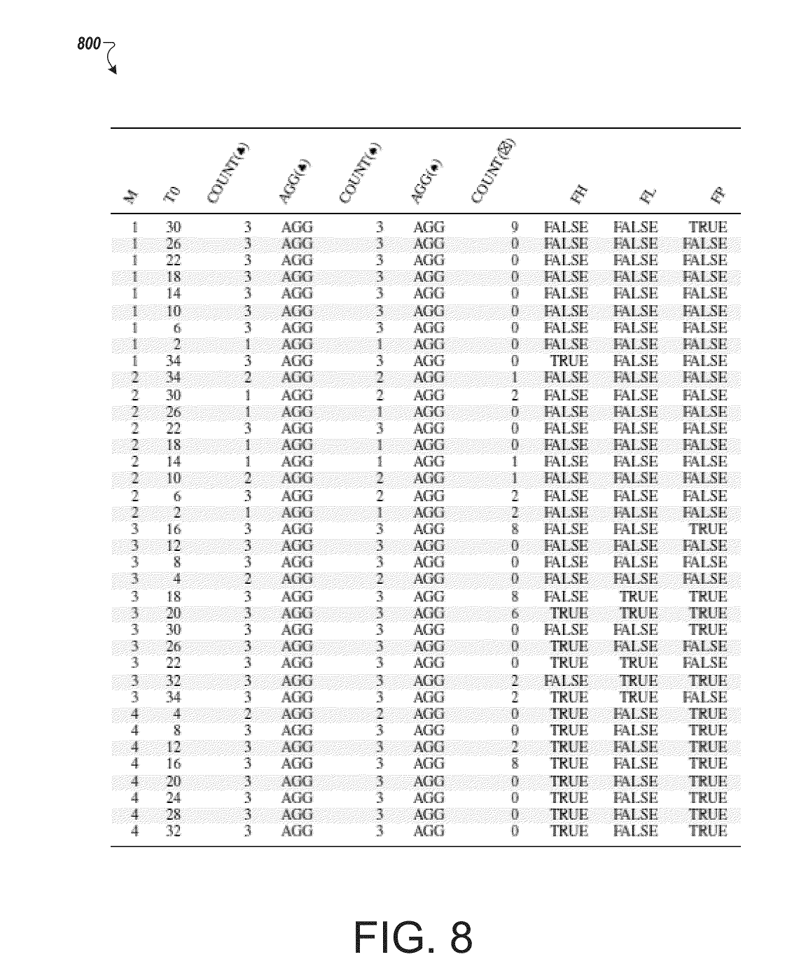

FIG. 8 an example of a third analysis table 800 prepared by and for use by an automated failure prediction system (e.g., the automated failure prediction system 150 shown in FIG. 1). The third analysis table 800 provides an example of backward windowing applied to example data (e.g., measurements and data for the set of machines 102 as shown in FIG. 1). The example data includes the parameters Δₚ=2, Δₕ=6, Δₗ=2, Δ₀=4, and AGGREGATES=ALL (i.e., no filtering is applied if windows are only sparsely filled; indicates if aggregations on sparsely filled intervals should be considered), NEG_FROM_POS=TRUE (i.e., negative examples are also generated from ailing machines), and Δᵢ=0, Δᵣ=0.

For the parameters, Δₚ is a prediction window size, Δₗ is a lead time, Δₕ is a history window size, Δ₀ is a step size, Δᵢ is an incubation time window, and Δᵣ is a recovery time window. For example, the procedure used by the model learning module 156 included in FIG. 1 to prepare the instances for the third analysis table 800 include taking each failure (including those that occur during a lead time) as a positive instance. The procedure also includes, from a failure point, moving a step size Δ₀ (in chronons) back along a timeline for generating a negative instance until either a previous failure is encountered in the prediction window or the beginning of the machine life is encountered.

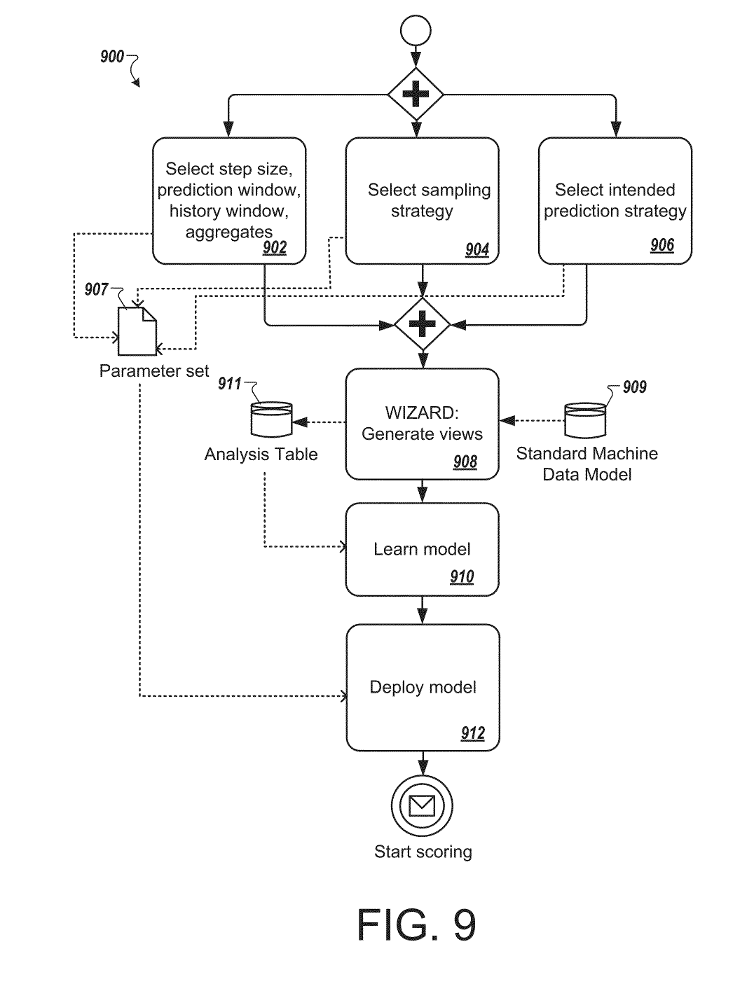

FIG. 9 shows an example flowchart 900 for generating and using an analysis table as a starting point for model learning and the classification of new incoming machine sensor data. For example, the system 100 shown in FIG. 1 can be used to generate the analysis table. The generated analysis table can be one or more of the analysis tables 400, 800, and 900 as described above with reference to FIG. 4, FIG. 8, and FIG. 9, respectively.

Values for a step size, a prediction window, a history window, and the aggregates to use are selected (block 902). For example, the selection of the values can be based on domain-specific criteria for the machinery (e.g., a land machinery domain). The selected step size, the selected prediction window, the selected history window, and the selected aggregates are included in a parameter set 907. The consideration of a sampling strategy for use with failing and non-failing machines is determined (block 904). The determined sampling strategy is included in the parameter set 907. Appropriate (domain-specific) values for a scoring strategy (an intended prediction strategy) are determined (block 906). The values for the determined scoring strategy are included in the parameter set 907. For example, the parameter set 907 can be stored in the database 142b.

Based on the selected parameters, the means for an in-database creation of an analysis table are automatically generated (block 908). A wizard receives data from a standard machine data model database 909 and creates an analysis table that can be included in the analysis table database 911. For example, the standard machine data model database 909 and the analysis table database 911 can be included in the computer system 130 (e.g., the standard machine data model database 909 and the analysis table database 911 can be included in the database 142b). The model is learned (block 910). For example, the model learning module 156 can use machine learning to process data included in the analysis table to identify failure patterns for machines. The model is deployed (block 912). The failure prediction module 158 can use the learned failure patterns to predict machine failures.

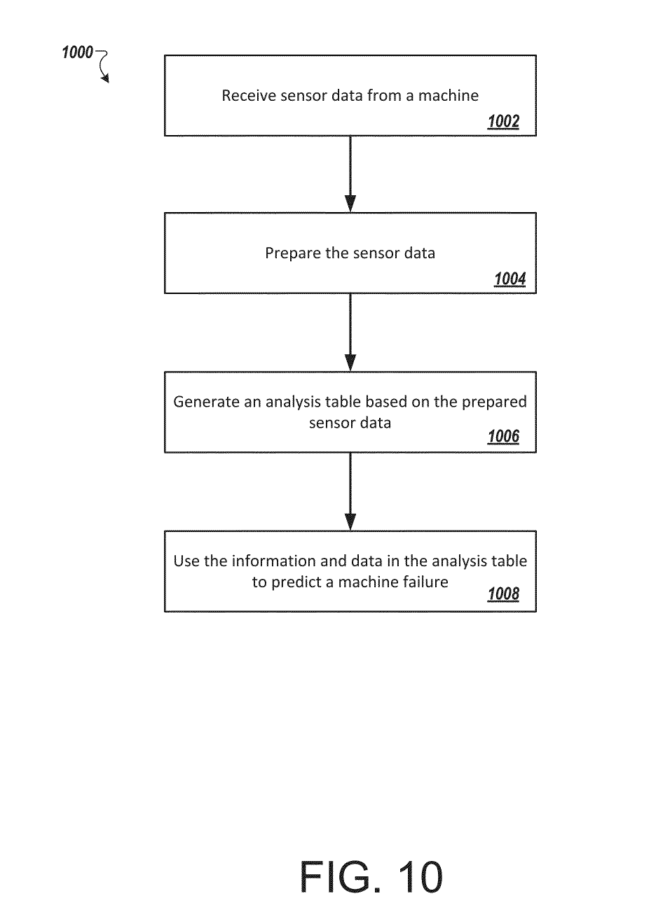

FIG. 10 is a flowchart that illustrates a method 1000 for predicting a machine failure. In some implementations, the systems described herein can implement the method 1000.

Sensor data from a machine is received (block 1002). The sensor data is prepared for use by data mining algorithms (block 1004). An analysis table based on the prepared sensor data is generated (block 1006). The analysis table can include information and data for a plurality of instances for the machine. The information and data included in the analysis table can be used to predict a failure of the machine (block 1008).

For example, the systems and methods described herein can be used for predictive maintenance of tractors, where the tractor can be considered the machine. A tractor can collect various sensor data that can include, but is not limited to, speed, engine speed, oil pressure, and/or fuel consumption. The sensor data can be gathered by taking regular/periodic measurements using the sensors. For example, a chronon of 30 minutes and a data window size Δ_{d}=1 can represent a case where sensor data is received every 30 minutes. In addition, alerts may be received at any time. Examples of such alerts can include but are not limited to low fuel level or high oil pressure.

A goal for the predictive maintenance of a tractor can be to predict a failure of the tractor with a lead time of 24 hours (Δₗ=48 based on a chronon of 30 minutes) and a prediction window of 24 hours (Δₚ=48 based on a chronon of 30 minutes). For example, rows in an analysis table (e.g., the analysis table 700) can describe a state for a plurality tractors (multiple machines) for each day or 24 hour period of time (a step size Δ₀=48 based on a chronon of 30 minutes). For the prediction problem, a behavior of the tractor (machine) in the last seven days (a history window size Δₕ=336 based on a chronon of 30 minutes (48 measurements/day×7 days)). For example, the following columns may be defined in the analysis table.

The maximum oil pressure in the last day can be expressed by Equation 11.

ƒ₁(t₀,48,0,Oil_{Pressure})=max(Oil_{Pressure[t}_{₀}_{-48,t}_{₀}]) Equation 11:

The number of occurrences of a high oil pressure alert within the last week can be expressed by Equation 12.

ƒ₂(t₀,336,0,Oil_Pressure_High)=Σᵢ₌₀³³⁶alertcount(Oil_{Pressure}_{_{High}},t₀−i)

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
receiving, at computing system, sensor data from a machine;
preparing the sensor data for use by data mining algorithms;
generating an analysis table based on the prepared sensor data, the analysis table including information and data for a plurality of instances for the machine; and
using the information and data included in the analysis table to predict a failure of the machine.

2. The method of claim 1, wherein the machine is included in a set of machines, and wherein receiving sensor data from a machine includes receiving sensor data from each machine included in the set of machines.

3. The method of claim 2, wherein the analysis table further includes information and data for a plurality of instances for each machine in the set of the machine.

4. The method of claim 1, wherein each instance includes at least one input variable and at least one target variable.

5. The method of claim 4, wherein the at least one target variable is indicative of a machine failure.

6. The method of claim 5, wherein the at least one target variable is indicative of one of a failure occurrence in a history window, a failure occurrence in a lead time window, and a failure occurrence in a prediction window.

7. The method of claim 4, wherein the at least one input variable is indicative of a state of the machine at a given point in time.

8. The method of claim 4, wherein the at least one input variable is indicative of an aggregate of the sensor data that was measured before a given point in time.

9. The method of claim 1, wherein generating the analysis table includes using one of backward windowing or forward windowing.

10. The method of claim 1, further comprising:
receiving an alert from the machine, the alert indicative of a specific state of the machine at a particular point in time, the alert having an associated timestamp indicative of the particular point in time.

11. A computer program product, the computer program product being tangibly embodied on a non-transitory computer-readable storage medium and comprising instructions that, when executed by at least one computing device, are configured to cause the at least one computing device to:
receive, at computing system, sensor data from a machine;
prepare the sensor data for use by data mining algorithms;
generate an analysis table based on the prepared sensor data, the analysis table including information and data for a plurality of instances for the machine; and
use the information and data included in the analysis table to predict a failure of the machine.

12. The computer program product of claim 11, wherein the machine is included in a set of machines, wherein receiving sensor data from a machine includes receiving sensor data from each machine included in the set of machines, and wherein the analysis table further includes information and data for a plurality of instances for each machine in the set of the machine.

13. The computer program product of claim 11, wherein each instance includes at least one input variable and at least one target variable.

14. The computer program product of claim 13, wherein the at least one target variable is indicative of a machine failure occurring in one or more of a history window, a lead time window, and a prediction window.

15. The computer program product of claim 13, wherein the at least one input variable is indicative of a state of the machine at a given point in time.

16. The computer program product of claim 13, wherein the at least one input variable is indicative of an aggregate of the sensor data that was measured before a given point in time.

17. The computer program product of claim 11, wherein generating the analysis table includes using one of backward windowing or forward windowing.

18. A system comprising:
a machine; and
a computer system including a server and a database configured to store an analysis table;
the machine including a plurality of sensors, the plurality of sensors configured to provide measurement data at an observation time, and the measurement data indicative of a state of the machine; and
the server configured to:
receive the measurement data from the machine,
generate the analysis table that includes an instance for the machine, the instance being based on the observation time for the machine and the instance including the measurement data and the state of the machine, and
determine a failure of the machine based on the state of the machine.

19. The system of claim 18, wherein the observation time is before a start of a lead time window and a start of a prediction window.

20. The system of claim 18, wherein the observation time is during a history window, the state of the machine is a failure state, and the analysis table does not include an instance for the machine based on the observation time for the machine.
